(19) United States
(12) Patent Application Publication
(10) Pub. No.: US 2003/0069760 A1
(43) Pub. Date: Apr. 10, 2003

(54) System and method for processing and pre-adjudicating patient benefit claims

(76) Inventor: Arthur Gelber, Ridgefield, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/972,129

(22) Filed: Oct. 4, 2001

(51) Int. Cl. G06F 17/60

(52) U.S. Cl. 705/4; 705/2

(57) ABSTRACT

A system and method for a rules-based pre-adjudication of a benefits claim submission is disclosed, wherein a patient claim benefit is pre-adjudicated in accordance with proprietary and commercial rules prior to submission to a policy issuing company to assure compliance with the terms and conditions of the patient benefit plan and to minimize error and maximize benefit reimbursement. Treatment plans are generated by examining treatments and conditions codes to arrive at appropriate treatment plans that identify other applicable treatments and conditions codes.

### TECHNICAL FIELD OF THE INVENTION

The present invention relates generally to benefit claim processing and invoicing insurance companies. The invention deals more particularly with a system and method for processing insurance claims and pre-adjudicating a patient's benefit plan according to the terms and conditions and schedules of a health care benefit plan independently of a policy issuing company's (PIC) internal adjudication process and outside the PIC universe. The invention also includes cost containment features and utilization review protocols such as managed care at the site rendering health care services.

### BACKGROUND OF THE INVENTION

The typical process of a conventional claim submission and adjudication generally starts at the health care provider wherein a patient is examined, a diagnosis rendered and a service or treatment provided. The health care provider or place of service then prepares or processes a claim to be sent to the patient's insurance company or benefit claim payer for reimbursement.

An insurance claim can be thought of as being divided into three sections as follows:

The first section contains the patient information, which includes the patient address, insurance identification number, and usually a group number if the insured is employed. If the patient has more than one insurance plan, the other insurance coverage is indicated in the balance of the patient information section of an insurance claim form.

The second section identifies the referring physician, the reason (the diagnosis is translated into an ICD-9 code) for the visit, the treatment rendered (medical procedures and supplies are translated into CPT codes) and the place of service. Any unusual events are reported into the physician section of the claim and the event is identified using a modifier code that is appended to the CPT code. Financial information is also reported in this section.

The third section or remainder of the claim identifies the rendering provider or supplier of the service, the address where the service was rendered, and the facility or physician identification number.

The foregoing information is transcribed onto the claim generally manually or data is entered into a computer by the medical facility's administrative staff. The claim is forwarded to the insurance company electronically or as hard copy by mail or equivalent delivery method. Current billing packages at the medical site will create a claim and enable the site to manually post payments. Typically, a medical site will work with billing software packages to provide accounts receivable information. Any other information to the medical site is very limited because the data is resident in the application and the only information available to the rendering provider of health care or the administrative staff comes from a suite of predefined reports that are available from the billing package.

The insurance company captures the claim data and begins adjudicating the claim against a patient's health care plan. The claim is adjudicated against the terms, conditions, limitations and exclusions, and any payment for health care services is predicated on the insurance coverage afforded the patient and any schedule of benefits noted in the patient health care contract with the PIC. After the patient's PIC has adjudicated a claim, it will yield a remittance statement or explanation of the benefits claim paid or rejected. The administrative staff at the medical facility or physician's office will contact the PIC to resolve issues related to uncompensated care and under payments for medical services rendered.

The PIC can deny or review a claim adjudication for a variety of reasons. For example, there may be missing patient information, double billing, unbundling of medical procedures, excessive treatments not medically necessary, patient is not insured, lack of authorization, no referral, wrong provider identification number, etc.

The present methods and systems for processing benefit claims and invoicing insurance companies are not satisfactory for a number of reasons. Primarily, physicians and medical facilities are not in the business of adjudicating health benefits. Physicians and medical facilities typically lack the information technology and insurance acumen necessary to efficiently administer health benefits claims and reimbursement.

The typical billing package software, such as described above, has limited functionality. It is designed to generate a claim, post a payment and invoice patients. In general, software programs are unable to manage textual information such as remark codes and descriptions related to denials or suspension of claim resolution. The shortcomings and lack of capabilities to manage such information makes the management of patient benefit plans, insurance industry adjudication protocols and identifying the logic behind the business rules associated with patient health care plans, and in general patient and insurance data, very costly, manually intensive, and laborious.

Insurance and managed care rules change frequently. Medicare, being the largest payer of benefit claims, changes rules every 45 days. There are over 4000 insurance companies and literally millions of rules applied to a single benefit plan. Further, the failure of health benefits claims not remaining in compliance can result in uncompensated care or charge backs for earlier reimbursements. The administrative chores of maintaining these rules and managing the financial impact to the medical site are daunting, costly, laborious, and manually intensive.

It is not uncommon for medical facilities, physicians, medical billing companies or collection companies or vendors in general to wait 40 to 90 days from the date medical services were rendered to receive an “explanation of benefits” statement (EOB) from the insurance company.

Further, based on the date the EOB was issued, a medical procedure could remain uncompensated for another 30-40 days. The administrative staff is left with the daunting task of intensive phone work to insurance companies trying to manage the changes associated with benefit plans and managed care rules and essentially the millions of different adjudication and managed care rules that can retard the reimbursement process. Most of this effort is costly and time consuming.

The cost of administration has grown over the last ten years and will continue to grow into the foreseeable future at a significant rate because of the volumes of rules and the frequency of changes in insurance coverage and medical protocols, as defined by the health care and managed care industry. The lack of technology and information has put the medical industry at a disadvantage. While the business risks increase and the quality of care is in jeopardy, many rendering providers are working longer hours and under more stress to keep up with the changes. Even with the additional effort, they are under constant threat of compliance issue violation for not following or applying the correct rules to health benefits claims.

The expense and hassles of administrating patient's insurance companies' rules, protocols, and changes in medical protocol or medical necessity, as well as recent increases in compliance reviews by auditors and the lack of information tools and technologies continue to overwhelm medical providers and staff. The poor communications and lack of understanding of relevant information between medical providers, administrative staff, and insurance company personnel have contributed to lost revenues and missed opportunities at medical sites.

It would be desirable therefore to provide a system and method for managing and administrating every patient's benefit plan, managed care protocol, utilization review standards, fee schedules, coding initiatives, and medical necessity protocols as defined by a patient's insurance company, and to incorporate and introduce the insurance companies' rules at the medical site essentially pre-adjudicating the claim (absent of any insurance company, third parties administration or PIC's intervention) prior to submitting the claim to the insurance carrier for adjudication. Such pre-adjudication would assure the medical industry that when medical services are rendered to their patients there is a reasonable expectation that the medical service rendered will be paid for after the claim has been adjudicated by the insurance carrier against a patient's health benefit or that a review or denial or treatment remuneration is comprehensible and appropriate.

### SUMMARY OF THE INVENTION

It is an object therefore of the present invention to provide a rules-based system (RBS) independent of any database resident at the insurance companies system or third party processor of insurance claims, for editing claims and pre-adjudicating a patient's benefit plan before any insurance claim is adjudicated by a policy issuing company (PIC). The RBS of the invention supports a data entry screen to enable the end user to do medical billing. The RBS accepts and outputs the insurance industry electronic standards to include clearinghouse functionality.

It is a further object of the RBS of the present invention to capture, in addition to its blend of information sources, including Medicare's guidelines (as directed by the Health Care Financing Administration), medical site data and insurance industry data, medical sites (claims) and EOB data and to update the patient's benefit plan according to its terms, conditions, limitations, exclusions, schedule of benefits, medical necessity protocols and the insurance companies' business rules.

It is yet a further object of the RBS of the present invention to flag and report by issuing a preliminary EOB when the health benefit claim's content data are likely to violate any of the patient's insurance companies adjudication rules, its business logic behind the benefit plan, benefit plan specific medical protocol standards, including violations that are likely to result in uncompensated medical services or a delay in medical reimbursements.

It is yet a still further object of the RBS of the present invention to gather comparative EOB data to validate the insurance company's adjudication process as well as the accuracy of the information contained in the remittance statement.

It is yet a still further object of the RBS of the present invention to compare EOB data against EOB data for accuracy to sustain the integrity of the system's databases.

It is also an object of the RBS of the present invention to standardize PIC issued EOB data, including remark codes and associated descriptions, to match EOB data against the initial claim, and distribute practice management analysis reports to identify potential hassle factors at the medical site.

It is an additional object of the RBS of the present invention to capture and convert antiquated claim forms and content, including EOB forms and content, into ANSI electronic formats for EDI transactions between medical sites, insurance companies, and/or the banking industry.

It is a further additional object of the RBS of the present invention to exchange data between health care constituents electronically online (real-time or batch), wherein data distribution information is downloaded into e-mail, message center, or directly into a claim data entry screen, and reports are downloaded and available onsite.

It is a yet further additional object of the RBS of the present invention to provide online compliance programs, including for example, correct coding initiatives, online medical documentation guidelines, medical documentation audit system, electronic medical documentation, Medicare and non-Medicare ICD-9 conventions, bundling and unbundling edits, identifying and maintaining multiple common procedures terminology (CPT) reduction rules, anesthesia crosswalk, CPT to ICD-9 crosswalk, a fee schedule matrix, pre-existing condition codes, identifying medical treatment and/or conditions that may be related to injuries, and medical specialty codes that identify when the medical treatment rendered is out of scope of the medical practice. Additionally, the RBS will identify those situations when either the CPT and/or the ICD-9 code usage is inappropriate, age and sex conflicts, place of service conflicts, misuse of modifiers and the inappropriate use of HCPCS codes.

It is a still further additional object of the RBS of the present invention to employ mapping algorithms that enable the RBS to identify the logic behind benefit plans, medical standards and correct coding initiatives of any insurance company. The mapping algorithms include such items as the multiple reduction rules, ranking CPTs according to the PIC's multiple reduction rules to define the insurance reimbursement schedule when a group of CPTs (medical procedures or treatments) are rendered during a single day. The RBS maintains “same day rules” that determine when multiple services rendered in a single day may not be covered, and therefore uncompensated. The insurance industry has a set of rules associated with “global periods.” When initial services, for example surgery, are performed, follow-up visits, such as removing stitches at a later day, are included in the initial or primary medical procedure and are therefore part of the global period. The RBS defines and reports the extent of the global period and reports those services or medical treatments that are subject to the global period rule.

It is a further goal of the RBS of the present invention to identify “positive edits” that report when missing procedure codes (CPTs) are not being identified on the claim. When the original claim is updated (the positive edits are included on the claim), the medical site will receive a higher reimbursement rate for the medical services rendered on the day the positive edits were added to the claim. The RBS also enables a medical facility to review retrospectively EOBs and process the data after the positive edits have been identified to report every date of service for which additional medical procedures should be billed to the insurance companies.

A feature of the RBS of the invention standardizes EOB data by organizing the data and identifying those details on the EOB that should be followed up and generating action types, for example, claim is approved, under review, or denied. This standardization capability focuses on specific details that should be followed-up and which are most likely to return an investment on the time spent with the insurance company.

A feature of the RBS's mapping algorithms benefit the end user by removing the guesswork from determining whether any denial of benefits or a review of the insurance claim is appropriate, and more importantly, the re-adjudication of the claim and EOB determines if the PIC's adjudication of the claim is correct.

In a further feature of the invention, the RBS manages provider agreements between a managed care organization and insurance companies. The reimbursement or allowances for medical services are included in the remittance data. The RBS considers the terms and conditions of a provider's agreement with the insurance company to validate that the adjudication of a claim is consistent with the terms and conditions set forth in the agreement. The algorithms associated with mapping EOB data flags underpayments and overpayments to a medical facility.

In a yet further feature of the invention, the RBS identifies medical treatments that are reimbursable by the patient's benefit plan so that medical providers prescribing treatment plans know which services are going to be compensated and which services are likely to be uncompensated. The feature also allows medical sites to pre-certify a claim wherein the patient's insurance company's financial obligation and the patient's projected financial obligation are identified at the time of the visit.

In a still further feature of the invention, a scheduler is integrated into the claim and EOB data entry screen. The scheduler allows the administrative staff at the medical site, during the scheduling process of a patient visit, to utilize the pre-certification functionality of the RBS to advise the patient of their financial responsibility prior to the date of the appointment or after the patient has seen the health care provider.

A still further feature of the RBS of the invention includes determining an insurance companies' reimbursement schedule for a patient's benefit plan by identifying the type and age of the database being used and considering the relative values and geographic factors when the RBS builds the insurance companies' reimbursement schedule databases. The RBS algorithms will re-price the claim and EOB according to a number of factors including the medical facility ZIP code, type of facility, type of specialty, provider agreements with managed care organizations, type of modifier utilized and the reduction of reimbursement for multiple medical treatments or procedures during a single patient visit as it is defined in the multiple reduction rule schedule. The re-pricing process also identifies zero dollars for non-covered services.

A yet further feature of the RBS of the invention incorporates quality control methodology such that when an insurance company inappropriately adjudicates a patient benefit plan, the RBS will audit and identify the error to begin the process of holding the insurance company accountable. Likewise, if the medical facility's administrative staff fails to correct its own error or continues to ignore compliance issues, the RBS will flag the facility and report potential false claim issues to help curb fraud and abuse.

A further methodology feature of the RBS reviews comparative data to generate report cards on health care constituents.

A further feature of the RBS includes Medicare's correct coding initiative, rules imbedded in Medicare's carrier manual and Medicare's adjudication logic including its reimbursement schedule.

A yet additional further feature of the RBS of the invention synchronizes current and historical data so that when data is processed according to the date of service, only rules that existed on the date of service are applied and rules updated after this date of service are not applied.

In a yet further feature of the RBS of the invention, the distribution of data is targeted to individuals who are responsible for the resolution of outstanding issues. Actions or action types associated with outstanding issues are defined by the RBS and distributed via e-mail to appropriate staff or personnel.

In a still further feature of the invention, the RBS methodology is self-regulating to assure data integrity.

### BRIEF DESCRIPTION OF THE DRAWINGS

Other objects, features and advantages of the present invention will become readily apparent from the following written description of preferred embodiments with reference to the drawings, in which:

FIG. 1 is a flowchart showing a prior art submission of a claim and adjudication of a claim benefit;

FIG. 2 is a flowchart showing a submission of a claim benefit pre-adjudicated in accordance with the present invention;

FIG. 3 is a functional block diagram of the rules-based claim benefit pre-adjudication system embodying the present invention;

FIG. 4 is a functional block diagram of the error response tickler system of the rules-based claim benefit pre-adjudication system shown in FIG. 3;

FIG. 5 is a flowchart showing the method of adjudicating ICD9 diagnosis codes in accordance with the rules-based claim benefit pre-adjudication system of the present invention;

FIG. 6 is a flowchart showing the method of adjudicating CPT codes in accordance with the rules-based claim benefit pre-adjudication system of the present invention;

FIG. 7 is a flowchart showing the method of generating a treatment plan in accordance with the rules-based claim benefit pre-adjudication system of the present invention;

FIG. 8 is a functional block diagram of the treatment plan generation method shown in FIG. 7; and

FIG. 9 is a flowchart showing the method of grouping into nuggets paid items identified on the explanation of benefits (EOB) by insurance company and benefit plan administrator.

### DETAILED DESCRIPTION OF THE PREFERRED EMBODIMENTS

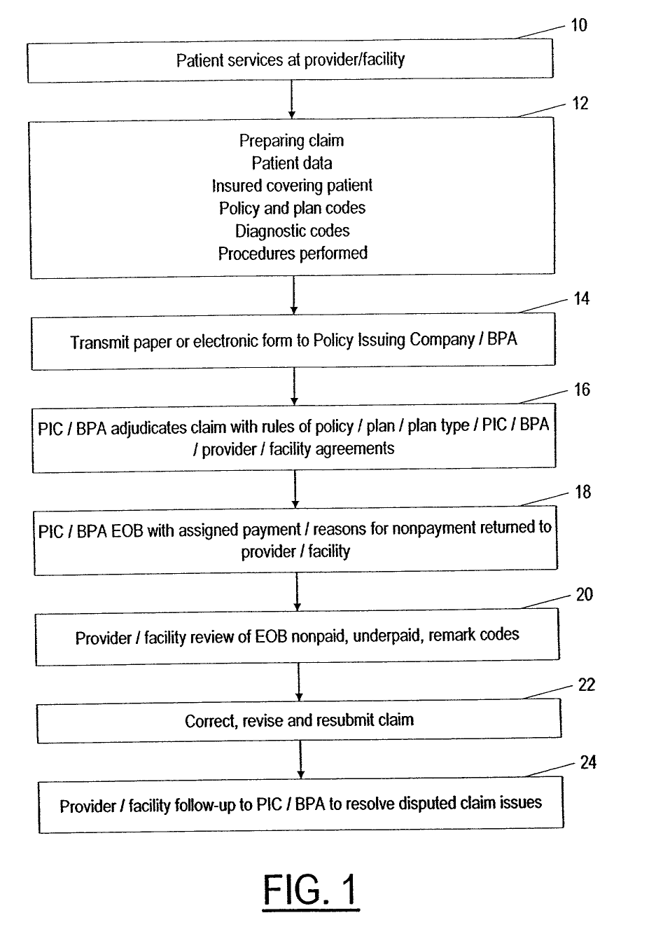

A flowchart showing a prior art submission and adjudication of a claim benefit by a PIC is illustrated generally in FIG. 1 and is representative of a typical claim processing of the prior art. In FIG. 1, a patient receives services at a health care provider or a facility as illustrated in step 10. Once the patient receives a diagnosis and treatment, a claim is prepared as illustrated in step 12, wherein the patient data is manually entered or possibly retrieved from an existing office record or file. A health benefit claim and any of its associated content such as medical referrals, authorizations, prescriptions and any other type of documentation are typically generated by the health care provider and/or medical facility. Other information such as the identity of the insured covering the patient and the typical policy and plan codes is included. The health care provider or medical facility would typically communicate on the claim the reason for the encounter with the patient and the type of treatment rendered to the patient using the health care industry's coding system. Currently used coding systems include: Common Procedure Terminology—American Medical Association (CPT); Health Care Financing Administration Common Procedure Coding System (HCPCS); International Classification of Diseases—9 Edition—Clinical Modification (ICD-9-CM Diagnosis and Procedure, including volumes 1,2, &3 of ICD-9-CM, and the ICD-10-PCS; Diagnostic Related Grouping (DRG); Ambulatory Patient Groups (APG); Ambulatory Payment Classification (APC), and Modifiers.

The claim in a paper or electronic form is forwarded in step 14 by the health care provider, medical facility or the patient to the policy issuing company or benefit plan administrator for processing and payment. Once the claim arrives at the policy issuing company/benefit plan administrator, the process of adjudicating the benefit claim begins as shown in step 16 in accordance with the rules of the policy and plan, plan type, and further in accordance with any agreements between the policy issuing company/benefit plan administrator and the provider or facility. The adjudication of a claim is a process initiated by the PIC to determine the health benefits afforded to each patient (or insured) under the benefit plan contract, including its limitations, exclusions, any schedule of benefit or reimbursement, any type of managed care provisions or any other entitlements or lack of entitlements. Included in the adjudication of a claim are reasons for the encounter (the ICD-9-CM) and the treatment rendered (CPT, APC, APG, DRG, and Modifiers), fees charged, and a PIC's compliance issues.

Once the claim is adjudicated by the policy issuing company/benefit plan administrator, an explanation of benefits (commonly referred to as an EOB) statement is generated as shown in step 18 with the assigned payments and/or any reasons for nonpayment and is returned with the payment to the health care provider/facility. Once returned to the health care provider/facility, the EOB is manually reviewed as shown in step 20 to identify any unpaid, underpaid or remark codes to compare those codes to the originally submitted claim.

Once the EOB is reviewed, the health care provider/facility attempts to correct, revise and resubmit the claim as illustrated in step 22. In this step, incorrect codes or non-applicable codes are corrected, if possible, incorrect descriptions of procedures are revised, and the claim is resubmitted to the policy issuing company/benefit plan administrator. The health care provider/facility personnel then follow-up as shown in step 24 to the policy issuing company/benefit plan administrator to resolve any disputed claim issues and further correct or modify the resubmitted claim. The process may be repeated until such time as all claims have been paid or a resolution to a disputed claim cannot be reached. The prior art process of claim submission and adjudication is time consuming, labor intensive and does not provide an indication or assurance of a likelihood that a claim will be paid.

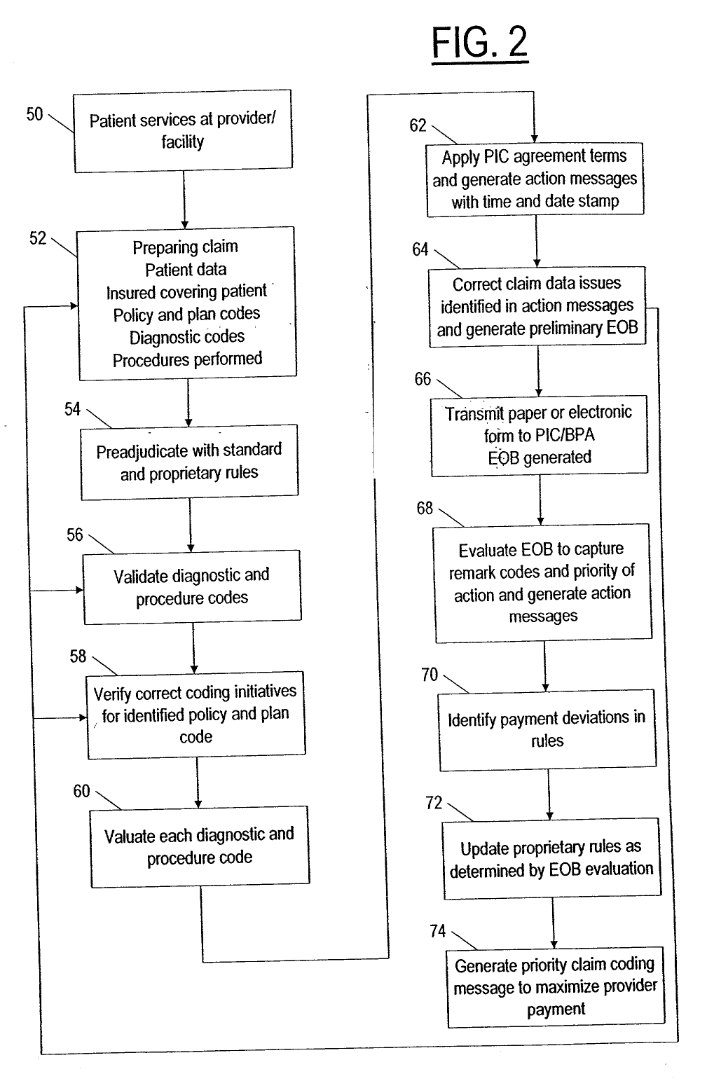

Turning now to FIG. 2, a flowchart showing a submission of a benefit claim pre-adjudicated in accordance with the Rules Based System (RBS) of the present invention is illustrated therein, wherein a patient receives services at a health care provider/facility as illustrated in step 50. In step 52, a claim is prepared in which the patient data is input either manually with an interactive computer system or is retrieved from patient records or other files within the health care provider/facility site or retrieved electronically from a central database or record. The entry of the patient data from pre-existing data facilitates the claim preparation and ensures accuracy.

The patient data includes information such as the insured covering the patient, policy and plan codes and other patient information (demographics) as necessary and desired. The condition, treatment and procedure codes conforming to the health care industry's coding system and corresponding to the services provided to the patient are entered either manually by the health care provider staff or downloaded or otherwise populating the data entry form as presented on the computer screen data entry form(s). This claim preparation step constitutes a trial claim which is pre-adjudicated in step 54 in accordance with the appropriate standard and proprietary rules of the RBS. The pre-adjudication is done outside the universe of PICs and provides to the health care provider site, medical facility, authorized individuals, other potential health care constituents or portal the predetermination of the remittance statement or EOB. The pre-adjudication process also yields informational reports that are distributed into legacy software applications or web enabled applications for consideration.

As part of the pre-adjudication process, the condition, treatment and procedure codes are validated as shown in step 56. In step 58, the correct coding initiatives for the identified policy and plan code are verified. Next, each condition, treatment and procedure code is valuated as shown in step 60 to identify the expected payment for the services rendered. The thus valuated claim is then subjected to the terms and conditions of any agreements that may exist between the policy issuing company and the health care provider as illustrated in step 62. Missing items, incorrect items or errors are generated in step 62 and are used to alert staff that corrective action is required. As explained further herein below, the action messages are entered into an error response tickler system for subsequent reminder messages indicating the type and nature of action required to continue processing the claim.

Claim data issues identified in the action messages are corrected as shown in step 64. A preliminary EOB is generated and analyzed, and a new status is assigned to the claim prior to the claim being transmitted in step 66 in paper or electronic form to the policy issuing company/benefit plan administrator. As part of the analyzation process, the RBS re-prices each line of the claim according to the PIC's benefit plan and/or the provider/facility ZIP code to generate the preliminary EOB. The action messages are time- and date-stamped to assure prompt and timely response by staff and for measuring and monitoring staff efficiency and performance. The claim data format is converted from paper/NSF 2.0 to ANSI X.12 format for electronic transmission.

Once the claim is transmitted to the policy issuing company/benefit plan administrator, an EOB generated by the PIC is returned to the health care provider/facility with the appropriate payment. In the present invention, the PIC EOB is evaluated in step 68 to capture any remark codes and priority of action relative to the code originally submitted and to generate action messages for further evaluation and/or activity. In step 70, deviations in the rules where payments have been made or deviations in the rules where payments have been omitted and should have been made are noted and used to update the proprietary rules of the RBS as shown in step 72. Once the system updates the rules, as determined in the PIC EOB evaluation, a priority claim-coding message is generated in step 74, which is used in subsequent claim processing for the best return on effort to maximize provider reimbursement.

The structure of the RBS is based on a blend of informational sources including national and local Medicare guidelines (as directed by the Health Care Financing Administration) and is thus dynamic in that the RBS is able to update and maintain PIC-Patient-benefit plan revisions at the local and national level. As explained further herein, the RBS includes a number of informational source databases that interact relationally with one another so that a change or consequence of any item is reflected throughout the RBS.

The core of the RBS includes a claim editor database that is constructed of eleven (11) edit tables each of which performs a separate and distinct function in identifying inappropriate or incorrect coding relationships. The claim editor identifies inappropriate coding relationships and line item information on provider and facility medical bills. The RBS identifies, reports, maintains and updates these rules by the PIC for every PIC included in the RBS. It will be recognized that the number of PICs in the RBS may be expanded and added at any time to accommodate, for example, a newly created PIC. The edit tables comprising the database and a brief description of each follow herein below.

### Procedure Description Table

The Procedure Description Table contains all of the CPT, HCPCS, DRG, APC and APG codes for the current year and the previous two years. These codes are processed by the RBS and compared with and validated by the appropriate codes in this table. In addition to validating procedure codes, this table provides a message to identify bilateral or digital procedure codes. The table also identifies unlisted procedures or services and starred surgical procedures. The RBS identifies, reports, maintains, and updates these rules by individual PIC.

### ICD-9-CM Description Table

The ICD-9-CM Description Table contains all current ICD-9-CM volume 1,2, &3 codes. The ICD-9-CM codes processed by the RBS are compared to the codes in this table and validated by matching the code with the same code in the table. The table also provides coding conventions, that is, PIC and benefit plan specific information that indicates if the ICD-9-CM code requires an additional fourth and/or fifth digit to be more specific, and covered and non-covered ICD-9-CM codes. The RBS identifies, reports, maintains, and updates these rules by PIC.

### CPT-HCPCS/ICD-9CM Crosswalk Table

The CPT-HCPCS/ICD-9CM Crosswalk Table cross-references CPT and HCPCS codes with Medicare's commonly associated ICD-9 diagnosis codes, and PIC and/or benefit plan specific crosswalks on a local and national level. Most of the edits in the RBS knowledge database are non-permissive (negative) edits. However, the CPT-HCPCS/ICD-9CM Crosswalk Table is a permissive (positive) edit table. The table is keyed to the CPT and HCPCS code that has at least one listed ICD-9-CM range. The edit is performed by line item to determine a specific CPT and HCPCS to ICD-9-CM correlation. The intent of this edit is to capture 85 to 95 percent of the valid associations in the health care industry. The RBS identifies, reports, maintains, and updates these rules by PIC.

### Anesthesia Crosswalk Table

The Anesthesia Crosswalk Table links surgical, radiology, and medical CPT codes to anesthesia CPT codes. Approximately 265 anesthesia CPT codes represent anesthesia services for several thousand surgical, radiology, and medical CPT codes. Because anesthesia codes are grouped by anatomical area, many surgical CPT codes cross over to a single code. The RBS identifies, reports, maintains, and updates these rules by PIC.

### Diagnosis Edit Table

The Diagnosis Edit Table identifies parameters associated with the following four separate diagnoses edits: third-party liability; preexisting condition; sex, and age. Parameters with the Diagnosis Edit Table identify characteristic elements that may be significant to the reimbursement process. The edit categories in the RBS are informational edits that identify inconsistent coding relationships. The RBS identifies, reports, maintains, and updates these rules by PIC.

### Assumptions

Third-party liability issues and/or possible coordination and/or subrogation of benefits are some of the ICD-9-CM edits in the RBS.

Preexisting conditions are identified by an ICD-9-CM code that has the clinical possibility of a long period of evolution.

Sex ICD-9-CM codes with gender-specific descriptions are identified in the RBS edits.

Age edits in the RBS identify a normally accepted age range for each ICD-9-CM code.

### Modifier Edit Table

The Modifier Edit Table identifies CPT and HCPCS codes that are appropriate for a given modifier. Guidelines provided in current CPT, HCPCS, and Medicare publications are integrated into the RBS's logic used to determine appropriate code/modifier relationships. Physical Status (PS) modifiers P1-P6, which are unique anesthesia modifiers, are also included in the RBS's logic. The RBS identifies, reports, maintains, and updates these rules by PIC.

### Prior Approval

This edit identifies CPT codes representing procedures or treatments that require preauthorization of health benefits or prior approval. The RBS maintains PIC benefit plan specialty by patient rules for prior approval. The RBS identifies, reports, maintains and updates these rules by PIC.

### Preexisting

This RBS edit category identifies CPT codes representing invasive procedures that are related to a preexisting condition. Preexisting conditions are those diseases that often are clinically present with a long period of evolution. The RBS identifies, reports, maintains, and updates these rules by PIC.

### No Surgical Assistant

This RBS edit identifies CPT codes representing procedures that do not require a surgical assistant. The RBS identifies, reports, maintains, and updates these rules by PIC.

### Multiple Procedures Reduced

This RBS edit identifies CPT codes representing procedures that, when billed as multiple procedures, may be subject to a multiple procedure fee reduction. The RBS identifies, reports, maintains, and updates these rules by PIC.

### Place of Service

This RBS edit identifies inappropriate relationships between CPT codes and place of service. The RBS identifies, reports, maintains, and updates these rules by PIC. The place of service (POS) is defined as: physician office/clinic; patient's home; inpatient hospital; nursing facility/nursing home; emergency department; independent laboratory; others as those services facilities not identified otherwise, and outpatient hospital/surgical centers. Some POS definitions are also applicable to the following six-edit categories of the Procedure Edit Table: non-physician services; surgical tray; ambulatory surgery center; office surgery preferred; non-emergency services, and Modifier-26 mandate.

Physician office/clinic includes urgent care facilities, radiology and MRI centers, cardiac clinics, and other similar physician specialty clinics. Patient's home is a private residence where patient receives care. Inpatient hospital is defined as a facility that primarily provides diagnostic and therapeutic (both surgical and non-surgical) services by or under the supervision of physicians to patients admitted for a variety of medical conditions and include inpatient psychiatric facilities. Nursing facility describes a facility that primarily provides inpatient skilled care. It does not provide the level of care or treatment available in a hospital and includes hospice, intermediate care/mentally retarded facility, nursing home, and skilled nursing facility. Emergency department is purely the “emergency room” of a hospital. It is that portion of a hospital where emergency diagnosis and treatment of illness or injury is provided. Independent laboratory is defined as a laboratory certified to perform diagnostic and/or clinical tests independent of an institution or a physician's office and includes mobile chest x-ray units, birthing centers, custodial care facilities, land, air, or water ambulance, military treatment facilities, community mental health centers, residential substance abuse treatment facilities, comprehensive inpatient rehabilitation facilities and comprehensive outpatient rehabilitation facilities. Outpatient centers include ambulatory surgical centers, partial psychiatric facility hospitals, hospital observation areas, hospital based clinics, outpatient surgery centers, outpatient physical therapy centers, outpatient occupational therapy centers and outpatient speech therapy centers.

### Nonphysician Services

This RBS edit identifies procedures that are commonly performed by non-physician personnel in a particular place of service. The RBS identifies, reports, maintains and updates these rules by PIC.

### Surgical Tray

This RBS edit identifies CPT codes representing procedures for which a surgical tray should not be reimbursed in a particular place of service. The five types of surgical trays in this edit are: Minor skin tray; Minor ortho tray; Major Skin Tray; Major ortho tray; Specialty kit tray (e.g., spinal tap tray, peritoneal lavage tray, amniocentesis tray). The surgical tray edit applies only to the primary procedure, based on the billed charge when multiple procedures are billed together. The RBS identifies, reports, maintains, and updates these rules by PIC.

### Ambulatory Surgical Center Preferred

This RBS edit identifies procedures that are usually safely, performed in an ambulatory surgical center (ASC) or outpatient hospital instead of an inpatient setting. The RBS identifies, reports, maintains, and updates these rules by PIC.

### Office Surgery Preferred

This RBS edit identifies codes representing procedures that are more appropriately performed in an office surgical setting as opposed to an ASC or an outpatient/inpatient surgical facility. The RBS identifies, reports, maintains, and updates these rules by PIC.

### Nonemergency Services

This RBS edit identifies codes representing procedures usually considered nonemergency, even for procedures performed in an emergency department. The RBS identifies, reports, maintains, and updates these rules by PIC.

### Modifier-26 Mandate

This RBS edit identifies those procedures where the separately identifiable technical component (TC) is billed by an entity other than the physician. The intent of this edit is to indicate procedures where a physician should bill a professional component only based on a particular place of service. The professional component (PC) is the separately identifiable physician involvement or evaluation/interpretation of generated information. The PC is represented by the CPT modifier-26. CPT codes with a PC/TC split are identified in the RBS edit for the following place of service: inpatient hospital, emergency department and outpatient hospital/surgical centers. The RBS identifies, reports, maintains and updates these rules by PIC.

### Age

This RBS edit identifies reasonable ranges for CPT codes. Age ranges are based upon the appropriateness of the procedure in relationship to the age. The RBS identifies, reports, maintains, and updates these rules by PIC.

### Maximum Frequency Per Day

This RBS edit identifies the frequency of a given service that exceeds a given norm in a 24-hour period. This edit profiles volume performance. Maximum frequency per day is identified from the viewpoint of clinical feasibility versus probability of occurrences. Clinical judgment is used to resolve discrepancies between feasibility and probability. Medical peer review boards or the PIC's medical director usually determines this judgment. The RBS identifies, reports, maintains, and updates these rules by PIC.

### Follow-up Days

This RBS edit identifies the number of follow-up days that are incorporated into the “global surgical package.” The number of follow-up days assigned to each surgical CPT procedure code is based on clinical assumptions defined by the PIC's medical review department, including using information from various professional associations and Medicare. The RBS identifies, reports, maintains, and updates these rules by PIC.

### Unbundle Table

This RBS edit compares CPT and HCPCS codes, including ASCs, to find procedures that should not be billed together. In general the unbundling types are as follows:

Unbundling: includes procedures that are basic steps necessary to complete the primary procedure and are by definition included in the reimbursement of that primary procedure;

Incidental: includes procedures that can be performed along with the primary procedure, but are not essential to complete the procedure. Incidental procedures are not separately reimbursable when performed with the primary procedure; and

Error: includes procedures which, when submitted together, are an unlikely combination. The RBS identifies, reports, maintains, and updates these rules by PIC.

### Transfer

This RBS transfer table is a filtering process linked by the Grouper and Rebundle tables. This table identifies the groups that rebundle. The RBS identifies, reports, maintains, and updates these rules by PIC.

### Grouper

This RBS table identifies potential groupings of CPT and HCPCS codes that rebundle to more appropriate codes. The table acts as an interim step between the unbundle edit table and the rebundle edit table. The RBS identifies, reports, maintains, and updates these rules by PIC.

### Rebundle

The Rebundle Table correlates directly with the Grouper Table. This table provides a listing of the CPT and HCPCS code (or codes) that should be replacing those originally listed on the claim. The RBS identifies, reports, maintains and updates these rules by PIC.

Examples of the benefits that may be pre-adjudicated by the RBS include medical benefits, hospital benefits and PIC specific benefits, as well as any other PIC adjudication rule. It will be recognized that the following identified benefits are presented by way of example only. The RBS of the present invention contemplates these and other benefits common to the health care industry and which benefits are now known or future-defined.

Medical benefits encompass for example: office/home visits; well child care; well woman care; surgical service; surgical assistance; anesthesia; in-patient visits; maternity care; diagnostic X-rays; lab tests; chemotherapy and radiation therapy; second surgical opinion; mental and nervous conditions including number of out-patient visits per benefit or calendar year; number of psychiatric emergency visits per benefit or calendar year; number of in-hospital doctor visits per benefit or calendar year; mammography screening; diagnostic screening tests; physical therapy including number of home or office visits per benefit or calendar year; and number of days in-patient services per benefit or calendar year; prosthetic and orthotic appliances and durable medical equipment; ambulance, and prescriptive drugs.

Hospital benefits encompass, for example: in-patient number of days—semi-private room and board; other hospital-provided services, facilities, supplies and equipment.

Routine nursing benefits encompass, for example: outpatient ambulatory surgery; surgery; pre-surgery testing; chemotherapy and radiation therapy; blood and mammography screening; physical therapy; diagnostic x-rays, and lab tests.

Emergency room/facility (initial visit) benefits encompass, for example: accidental injury and sudden and serious medical condition, mental and nervous; number of in-patient days per benefit or calendar year; alcohol/substance abuse including the number of out-patient visits including family counseling visits per benefit or calendar year; in-patient physical medicine; home health care including the number of visits per benefit or calendar year, and hospice.

PIC specific guidelines encompass, for example: clinical practice guidelines including adult preventive health guidelines; prenatal health guidelines; pediatric health guidelines; HIV medical evaluation and preventive care for adults; elevated cholesterol detection and treatment; hypertension screening, assessment and treatment guidelines; diagnosis and assessment of diabetes mellitus in adults; post-discharge evaluation and management of patients with acute myocardial infarction; congestive heart failure management guidelines for adult populations; asthma management guidelines; community-acquired pneumonia guidelines; pediatric otitis media guidelines; depression management guidelines; atrial fibrillation, and end-stage renal disease clinical practice guidelines.

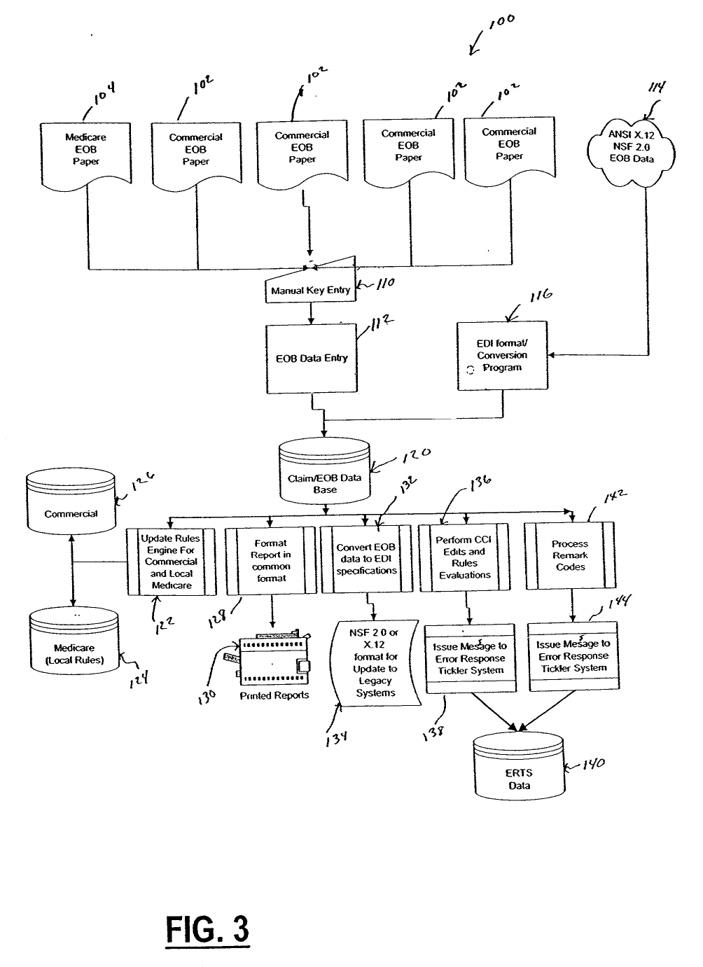

Considering the invention further and now turning to FIG. 3, a functional block diagram of the rules-based claim benefit pre-adjudication system is illustrated therein and generally designated 100. The RBS at a provider site may initially be populated with patient data to create patient profiles based upon existing information and historic PIC EOB summaries. As illustrated in FIG. 3, the EOB information may appear on commercial payer paper records 102 or Medicare payer paper records 104, and which patient data and PIC EOB information is scanned in a paper format and input to the claim/EOB database, generally designated 120.

The EOB patient data information may also be manually entered via a keyboard entry, generally designated 110, utilizing prompt and screen format templates in an interactive system to generate the EOB data as appropriate for each of the patients populating the claim/EOB database 120, and which information is entered via the EOB data entry function block 112. The patient data and/or historical EOB information may reside in other proprietary databases or health management records and which records are retrieved and electronically formatted for transmission in the ANSI X.12 or NSF 2.0 format as shown generally at 114. The electronic data interchange format of the patient data is transformed to the necessary data format required by the claim/EOB database 120 via the conversion program, generally designated 116. Accordingly, the RBS can accept any data input for conversion to the appropriate EDI format and protocol to communicate with any other system.

Once the claim/EOB database 120 is initially populated or as it receives new information during usage, the data is used to update the rules engine for adjudicating commercial and local Medicare payments and which commercial and Medicare local rules are stored in the database generally designated 124 while the commercial or proprietary rules are stored in the database generally designated 126. The data in the claim/EOB database may also be retrieved to format reports in a common format as shown generally at 128 for printing at a printer or other image generating device, generally designated 130. Likewise, the claim/EOB data can be converted into electronic data interchange specifications as shown generally at 132 for conversion to electronic format in the ANSI X.12 or NSF 2.0 format for updating to legacy systems as indicated generally at 134.

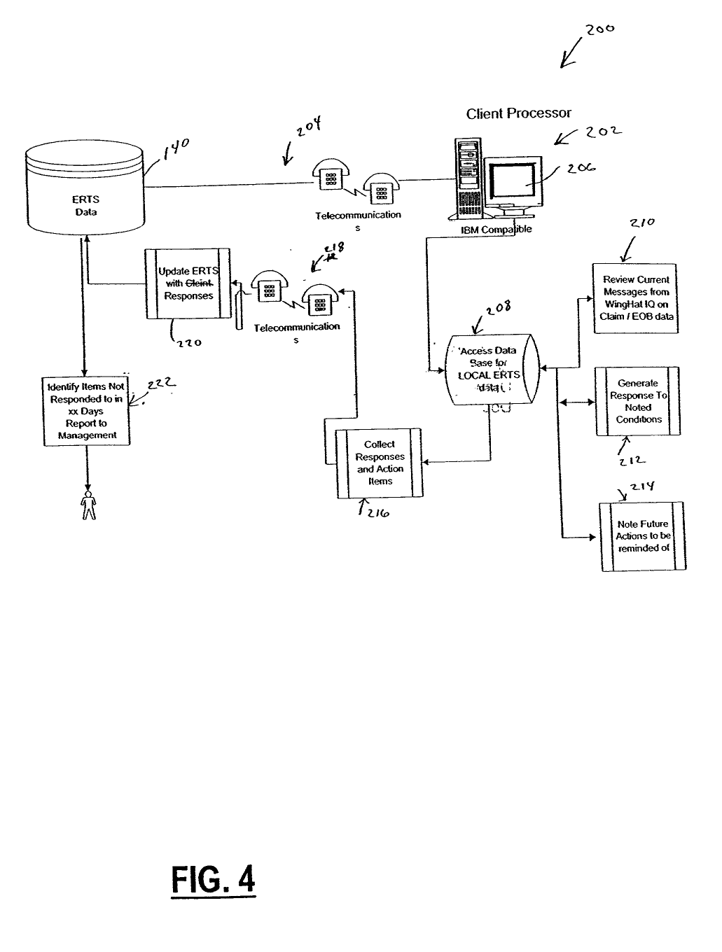

Correct coding initiatives, edits and rule evaluations as generally shown at 136 are performed on the claim/EOB data and messages are issued to the error response tickler system as shown at 138 for transmission to the error response tickler system database shown generally at 140. Additionally, the claim/EOB data can be examined and remark codes processed as shown at 142 to issue messages to the error response tickler system as shown at 144 and input to the error response tickler system database 140. The data in the error response tickler system database 140 is used to alert the health care provider/medical facility administrative staff that a response or specific action is required to continue or complete processing and is updated with the health care provider/facility responses as shown in further detail in FIG. 4.

Turning now to FIG. 4, the error response tickler system database 140 is part of an interactive communication system with the health care provider/facility shown generally at 202. The health care provider/facility 202 communicates with the error response tickler system database 140 via a communication link, generally designated 204, which may take any of a number of forms presently known or future-developed and for purposes of illustration is shown as a standard dial-up telephone communication line. Messages issued to the error response tickler system are communicated to the health care provider/facility 202 and shown on a computer screen 206 or stored in a file for subsequent retrieval and display and/or printing for use by the health care provider/facility.

The interactive communication system accesses the database for local error response tickler system data messages, which are stored generally at 208. The messages relative to the claim/explanation of benefits data is reviewed as shown generally at 210 and appropriate responses to noted conditions are generated as necessary as shown at 212. In addition, future actions requiring subsequent reminder notification are stored for retrieval at 214. The local error response tickler system database 208 is updated with the generated responses and future reminder actions, which are in turn collected as shown at 216 for conversion to a data format for use in the interactive communications network 218, shown as a standard telephone dial-up network.

The data is sent to the error response tickler system database 140 via the update error response tickler system with health care provider/medical facility responses interface 220. Any items residing in the error response tickler system database 140 requiring response within a given time period and not yet responded to are identified as a report to management, generally shown at 222. The error response tickler system database is updated as new information is input into the system or as required through rules updating and interaction with the health care provider/facility.

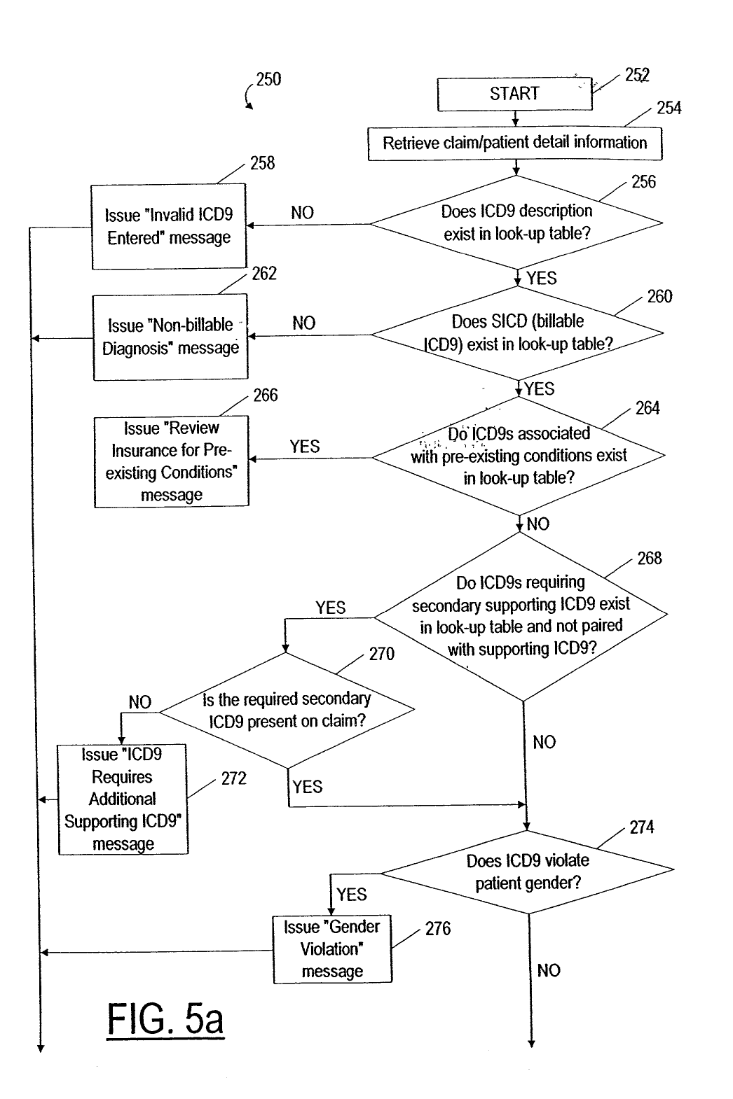

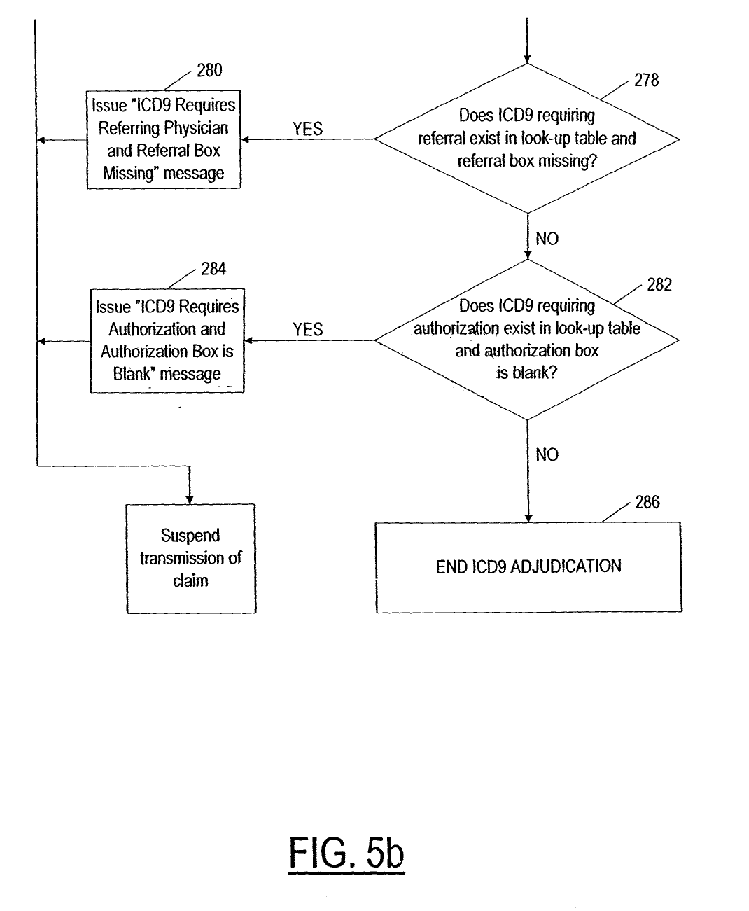

Turning now to FIG. 5, a flowchart showing the method of adjudicating and validating ICD9 diagnosis codes in accordance with the RBS is illustrated therein and is generally designated 250. The method starts at step 252 with the retrieval of claim/patient detail information as shown in step 254, which captures all of the claim data entered on the claim being prepared for submission.

Each ICD9 is examined in the claim detail in step 256 to determine whether the ICD9 description exists in the look-up table of ICD9s. If the ICD9 description does not exist in the look-up table, an “invalid ICD9 entered” message is issued as shown in step 258, and a “suspend transmission of claim” signal is issued to stop processing until such time as the valid ICD9 description is entered into the claim data. If the ICD9 description does exist in the look-up table, the process moves to step 260 to determine if an SICD (billable ICD9 code) exists in the look-up table of SICDs. If an SICD does not exist in the look-up table, a non-billable diagnosis message is issued in step 262 and the transmission of the claim is suspended until such time as the correct SICD is entered into the claim detail. If an SICD does exist in the look-up table, the system moves to the step 264 wherein the claim is examined to determine whether ICD9s associated with pre-existing conditions exist in the look-up table. If ICD9s associated with pre-existing conditions do exist in the look-up table, a “review insurance” message is generated at step 266 indicating that the insurance should be reviewed for pre-existing conditions to determine coverage.

If no ICD9s associated with pre-existing conditions exist in the look-up table, the system moves to step 268 to determine if ICD9s requiring secondary supporting ICD9s exist in the look-up table and are not paired with the appropriate supporting ICD9.

If such ICD9s do exist, the system moves to step 270 to determine whether the required secondary ICD9 is present on the claim. If the required secondary ICD9 is not present on the claim, the system issues at step 272 a message that the “ICD9 requires an additional supporting ICD9” and suspends the transmission of the claim. If there are no ICD9s requiring secondary supporting ICD9s existing in the look-up table or if the required secondary ICD9 is present on the claim, the system moves to step 274 to determine if the ICD9 violates the patient gender. If the patient gender ICD9 is violated, a “gender violation” message is issued at step 276 and transmission of the claim is suspended.

If there is no ICD9 patient gender violation, the system moves to step 278 to determine if ICD9s requiring a referral exist in the look-up table and the referral box is missing. If such a combination is detected, an “ICD9 requires referring physician and referral box missing” message is generated at step 280 and transmission of the claim is suspended.

If there are no ICD9s requiring referral existing in the look-up table or such an ICD9 requiring referral exists in the look-up table and the referral box is present, the system moves to step 282 to determine if ICD9s requiring authorization exist in the look-up table and the authorization box is blank. Upon determination that an authorization is required and the authorization box is blank, an “ICD9 requires authorization and authorization box is blank” message is issued at step 284 and transmission of the claim is suspended.

If an ICD9 requiring authorization exists in the look-up table and the proper authorization is present on the claim, the system moves to the end of the ICD9 adjudication as shown in step 286.

It will be recognized that the ICD9 adjudication rules will automatically be updated as part of the RBS performing the evaluation and examination of a PIC-generated EOB to accommodate changing requirements. Such updates occur automatically without additional human intervention or initiation of an update.

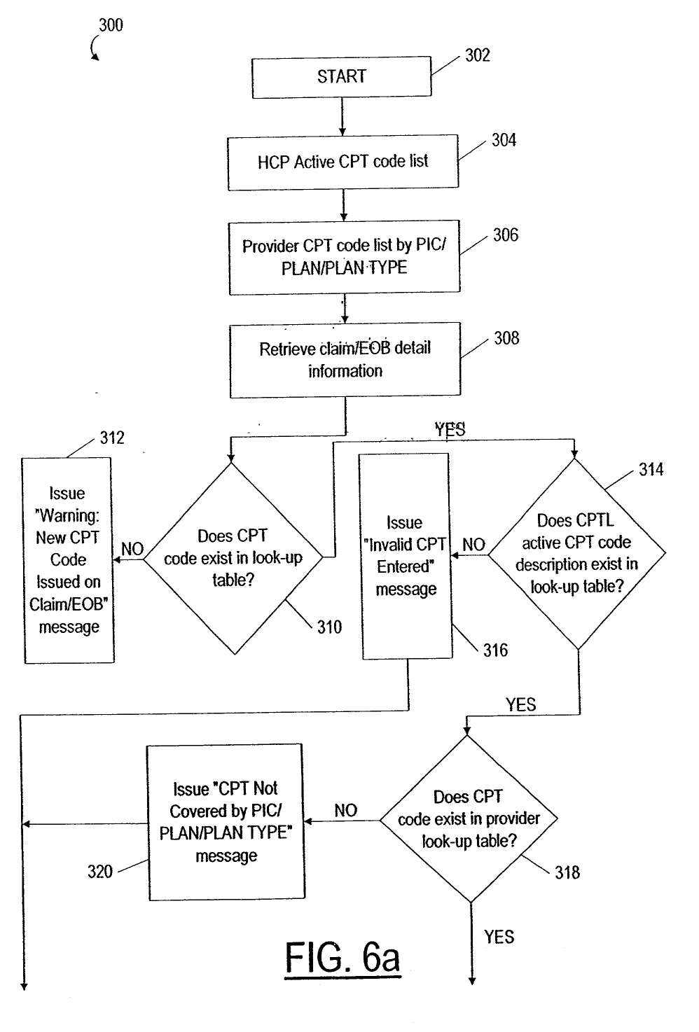

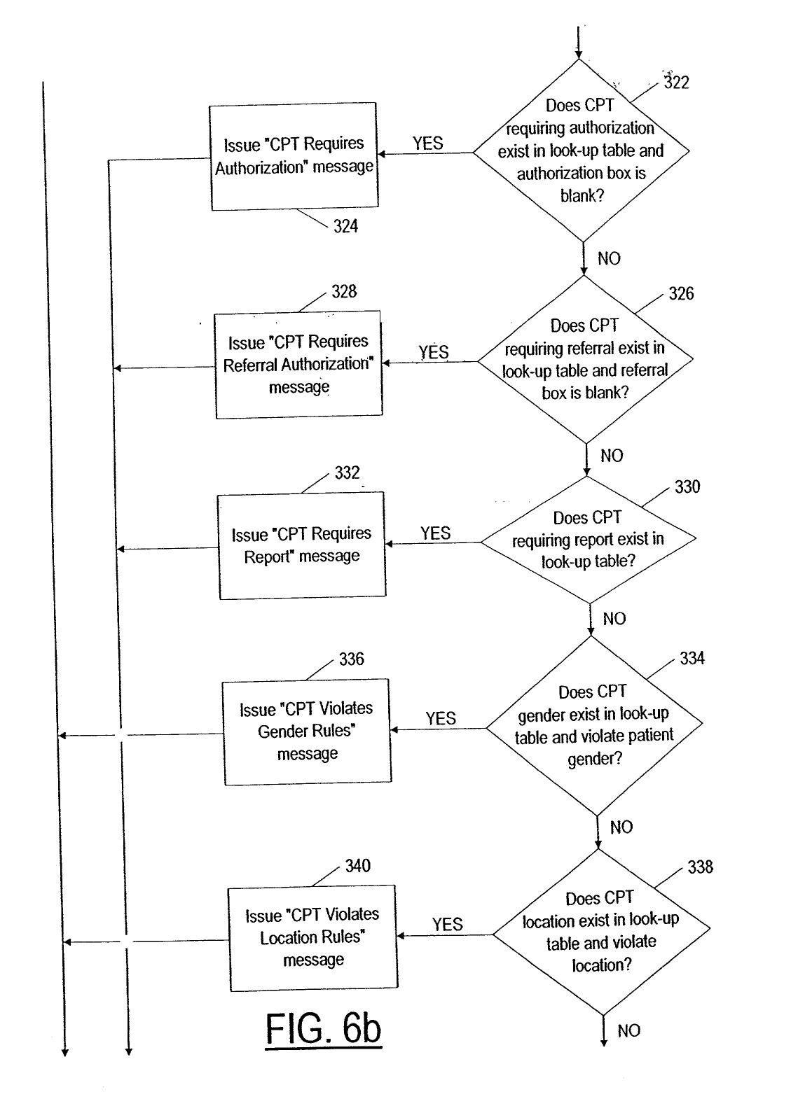

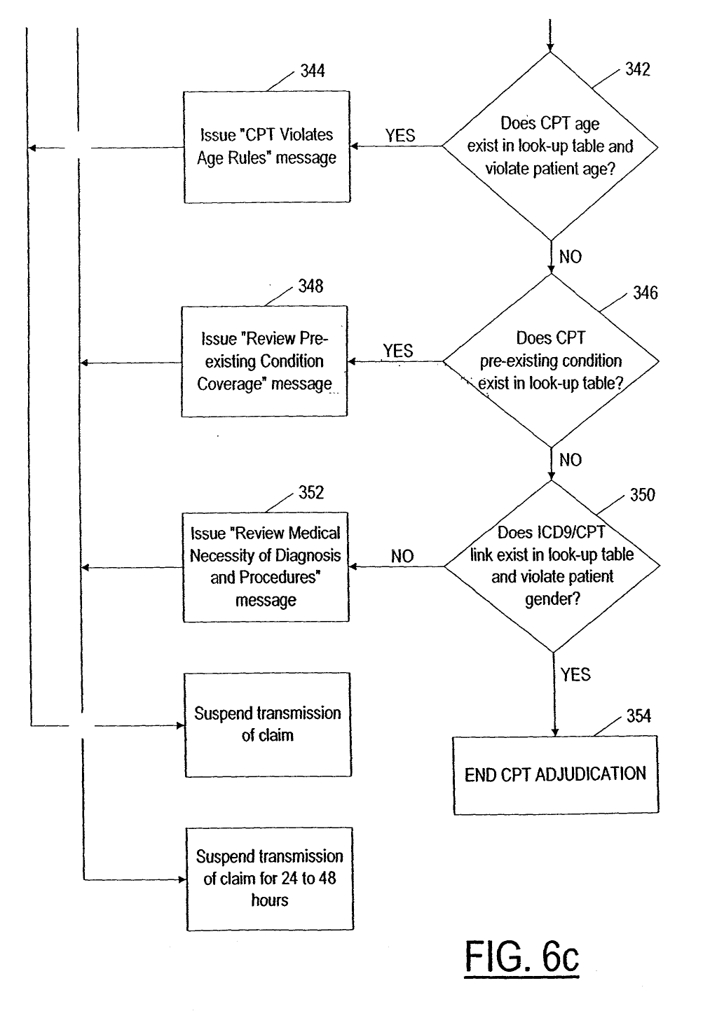

Turning now to FIG. 6, a flowchart showing the method of adjudicating and validating CPT codes in accordance with the RBS is illustrated therein and generally designated 300. The adjudication of the CPT codes is initialized at the start step 302. The active CPT codes for the health care provider/medical facility are listed and stored for look-up as shown in step 304. Next, the health care provider CPT code by the policy issuing company/plan/plan type list is generated and stored for look-up, as shown in step 306.

Once the CPT codes are listed, the RBS moves to retrieve claim/EOB detail information as shown in step 308. The CPT code is examined to determine if it exists in the look-up table of CPTs. If the CPT code does not exist in the look-up table, a message is issued warning that a “new CPT code is issued on the claim/EOB” as shown in step 312.

If the CPT code does exist in the look-up table, the system moves to step 314 to determine if the CPTL active CPT code description exists in the look-up table. If the CPTL code does not exist in the look-up table, an “invalid CPT entered” message is issued at step 316 and the claim transmission is suspended.

If the CPTL code does exist in the look-up table, the system moves to step 318 to determine whether the CPT code exists in the provider look-up table. If the CPT code does not exist in the provider look-up table, the system issues a “CPT not covered by policy issuing company/plan/plan type” message, as shown in step 320, and the transmission of the claim is suspended.

If the CPT code does exist in the provider look-up table, the system next examines in step 322 if the CPT requiring authorization exists in the look-up table and the authorization box is blank, and if such a condition is met, issues a “CPT requires authorization” message as shown in step 324, and suspends transmission of the claim for a given period of time, typically 24 to 48 hours, to provide the required authorization.

If the CPT requiring authorization exists in the look-up table and the authorization is present, the system then moves to step 326 to determine if a CPT requiring referral exists in the look-up table and the referral box is blank. If such a condition is present, the system issues in step 328 a “CPT requires referral authorization” message and suspends transmission of the claim for 24 to 48 hours to provide the required referral.

If the CPT requiring a referral exists in the look-up table and the referral box is present, the system moves to step 330 to determine if a CPT requiring a report exists in the look-up table, and if so issues a “CPT requires report” message in step 332 and suspends transmission of the claim for 24 to 48 hours within which to satisfy the report requirement.

If the CPT does not require a report, the system moves to step 334 to determine if the CPT gender exists in the look-up table and violates the patient gender. If this condition exists, a “CPT violates gender rules” message is issued in step 336 and transmission of the claim is suspended.

If the CPT gender does not violate the patient gender, then the system moves to step 338 to determine if the CPT location exists in the look-up table and violates the location requirement. If such a condition exists, a “CPT violates location rules” message is issued in step 340 and transmission of the claim is suspended.

If there is no violation and the CPT location exists in the look-up table, then the system moves to step 342 to determine whether the CPT age exists in the look-up table and violates the patient age. If this condition is met, a “CPT violates age rules” message is issued in step 344 and transmission of the claim is suspended.

If an age violation does not exist, the system moves to step 346 to examine if a CPT pre-existing condition code exists in the look-up table. If such a code exists in the table, a “review pre-existing condition coverage” message is issued in step 348 and transmission of the claim is suspended for 24 to 48 hours to allow such a review for pre-existing condition coverage.

If a CPT pre-existing condition code does not exist in the look-up table, the system moves to step 350 to determine if an ICD9/CPT linkage exists in the look-up table and violates the patient gender. If such a condition does not exist, a “review medical necessity of diagnosis and procedure” message is issued at step 352 and the transmission of the claim is suspended for 24 to 48 hours to allow review of the medical necessity.

If the ICD9/CPT linkage exists in the look-up table and violates the patient gender, the system moves to step 354 and ends the CPT adjudication. As in the case of changes in ICD9 requirements, changes in the CPT requirements as determined during the evaluation and examination of a PIC-generated EOB updates the CPT adjudication rules automatically without intervention.

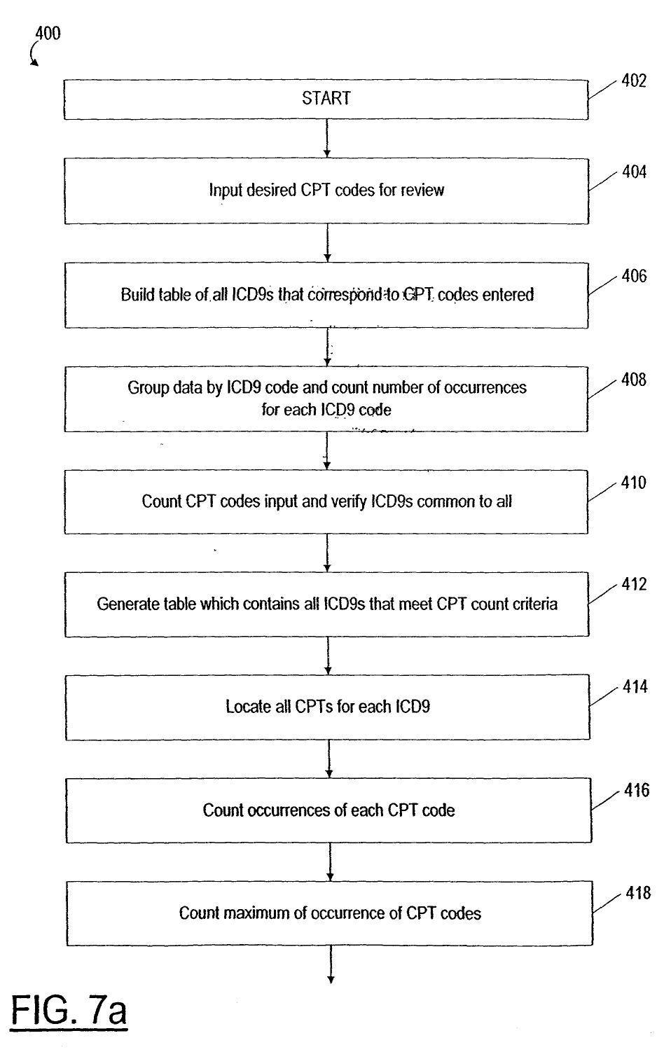

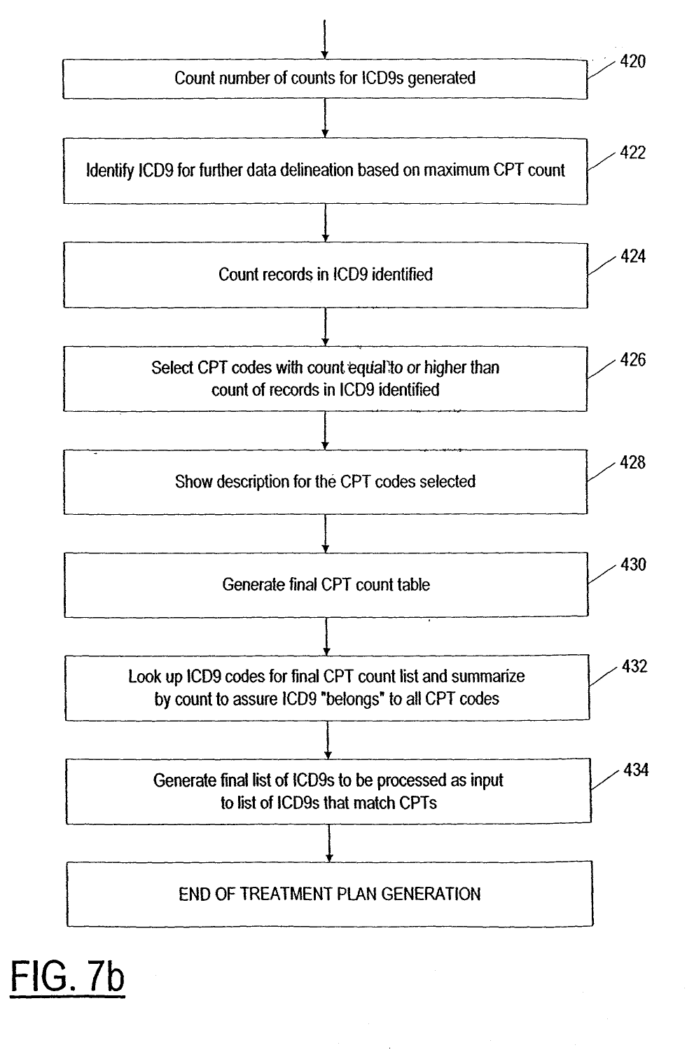

Turning now to FIG. 7, a flowchart showing the method of generating a treatment plan in accordance with the RBS is illustrated therein and generally designated 400. The method initializes at the “start” step 402 and the procedure begins with the entry of the desired CPT codes for review as shown in step 404.

The system then moves to step 406 to build a table of all ICD9s that correspond to each of the CPT codes selected or entered in step 404.

The system then moves to step 408 to group the data by ICD9 codes and counts the number of occurrences for each of the ICD9 codes.

The system then moves to step 410 to count the number of CPT codes that were entered and then verifies that the ICD9s are common to all the CPT codes entered.

The system then moves to step 412 to generate a table which contains all of the ICD9s that meet the CPT code count criteria. In this step, ICD9s that occur less than the total number of initial CPT codes are discarded.

The system then moves to step 414 to locate all CPT codes associated with all of the common ICD9s.

Once all of the CPTs for each of the ICD9 codes are located, the system moves to step 416 to count the occurrences of each of the CPT codes.

The system then moves to step 418 to count the maximum occurrence of CPT codes and then to step 420 to count the number of counts for the ICD9s generated.

The system then moves to step 422 to identify ICD9s for further data delineation based upon the maximum CPT count in step 418.

Once the ICD9s are identified in step 422, the system moves to step 424 and counts the records in the ICD9s identified.

Next, in the selection step 426, CPT codes with a count equal to or higher than the count of records in the ICD9s identified in step 424 are selected.

The system then moves to step 428 to show the description for the CPT codes selected in step 426.

The system then generates a final CPT count table in step 430 and moves to step 432 to look up ICD9 codes for the final CPT count list and summarizes by count to assure that the ICD9 belongs to all the CPT codes.

If the ICD9 does not belong to all the selected CPT codes, it is discarded, and the system moves to step 434 to generate a final list of ICD9s to be processed as input to the list of ICD9s that match the CPTs.

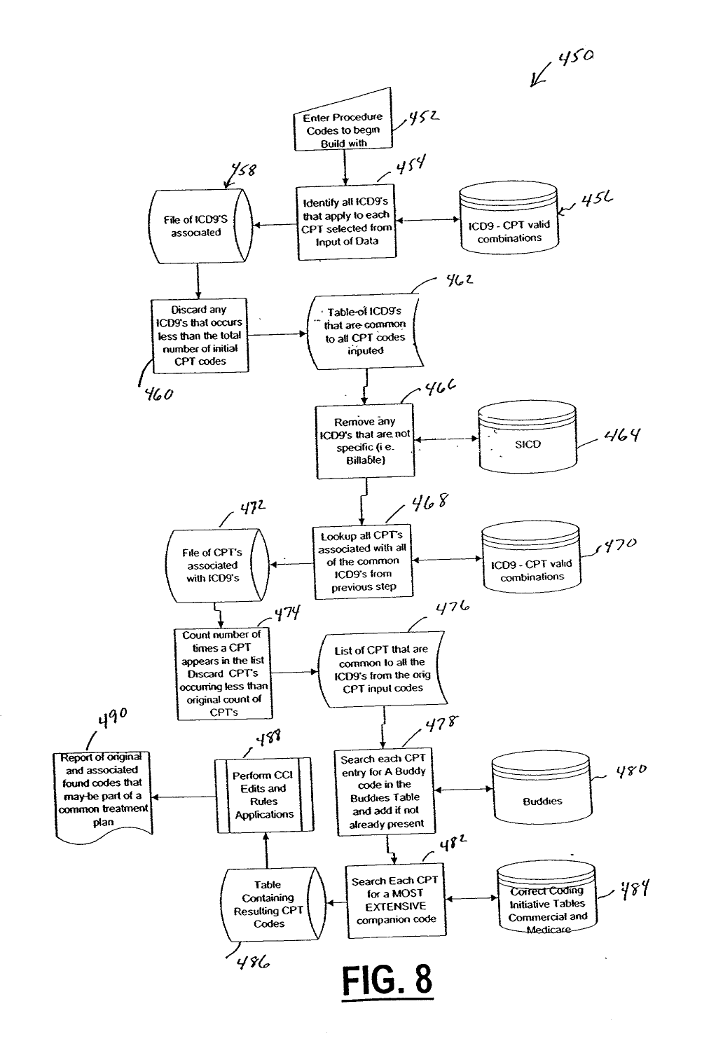

Turning now to FIG. 8, a functional block diagram of the treatment plan generation method of the RBS shown in FIG. 7 is illustrated therein and generally designated 450. The treatment plan is built by entering the procedure codes (CPT) as shown at 452. Once the procedure codes are entered, the system identifies all ICD9s that apply to each of the CPT codes selected from the data input as shown in function block 454. The identification is done by examining the valid combinations of ICD9s/CPTs in the ICD9/CPT valid combination database shown generally at 456.

The ICD9s identified are then set in a file of ICD9s as shown in the file structure 458. The file structure 458 is examined and the ICD9s that occur less than the total number of initial CPT codes selected from the data input are discarded in the comparison function block 460. The remaining ICD9s are listed in a table of ICD9s that are common to all the CPT codes in the input data as shown in the table function block 462. The ICD9s in the table 462 are examined and compared against the SICD database 464 to identify any ICD9s that are not billable and which non-billable ICD9s are then removed in the function block 466. A look-up of all of the CPTs associated with all of the common ICD9s remaining from the function block 466 and function block 468 is processed by examining the ICD9/CPT valid combination database 470 to generate a file of CPTs associated with ICD9s in the file structure 472.

Next, a counter in function block 474 counts the number of times a CPT code appears in the list in the file structure 472 and discards those CPTs that occur less than the original count of CPTs selected from the data input. The remaining CPTs are listed in a table 476 that contains CPTs that are common to all of the ICD9s from the original CPT codes selected from the data input.

Next, each CPT in table 476 is searched in the function block 478 by examining the buddies database 480, and if the buddy code is not present in the list of CPTs in the function block 476, the buddy CPT is added to the CPT list being searched in the function block 478. The CPT codes determined in function block 478 are searched in the function block 482 for a most extensive companion code through use of the correct coding initiative tables for commercial and Medicare standards as shown in the correct coding initiative tables and commercial and Medicare standards database 484. The results of the search in the function block 482 are provided in the file structure table containing the resultant CPT codes 486. Correct coding initiative edits and rules application are applied in the function block 488 to the resultant CPT codes listed in the file structure table 486.

The output of the correct coding initiative edits and rules application generates a report 490 showing the original CPT codes input and the associated found CPT codes that may be part of a common treatment plan. The services or procedures that correlate to given ICD9s can be grouped together so that various descriptions or characterizations of the service or procedure or diagnosis result in the proper CPT and ICD9 codes being chosen and selected as input to the patient's benefit claim with minimal “trial and error.”

A buddy code in the buddies table is generated by reviewing the documentation of the CPT and ICD9 code material to determine when a single CPT code can and should exist in the reporting structure with an associated CPT code. The buddies table can be referenced to determine if the treatment plan as evidenced by the claim submission is as complete as possible. Where there are missing associated buddy codes, the health care provider can be notified to review the treatment chart for the applicability of the buddy code in the treatment plan of the patient.

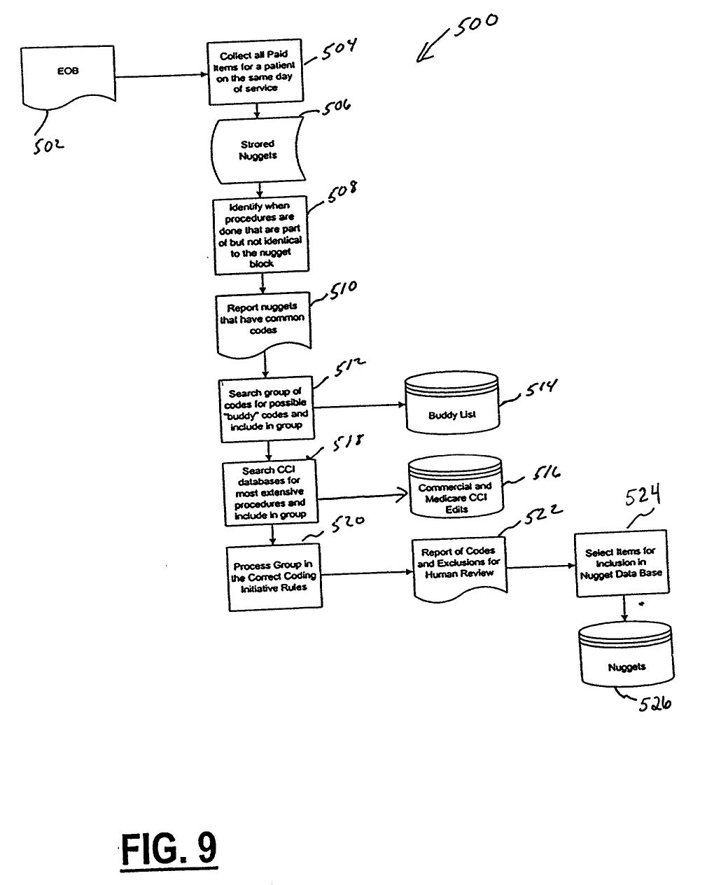

Turning now to FIG. 9, a flowchart showing the method of grouping into nuggets those paid items identified on a PIC-generated EOB is shown therein and generally designated 500. The concept of the nugget is to determine from a PIC-generated EOB which codes can be grouped by diagnosis and get paid. If the item group is paid once, it is likely that it will be paid again. In order to determine this, the EOB data, shown generally at 502, is scanned manually or electronically to create the data input. All the paid items for a patient on the same day of service are collected in step 504 and entered into a stored nuggets file 506.

Next, procedures that were performed that are part of but not identical to the nugget block are identified in step 508. Next, the codes in the nuggets are examined and those nuggets that have common codes are reported in the report step 510. The group of codes are searched for possible buddy codes in step 512 by examining the buddy list in the buddy database 514 and included in the group of codes identified in the report step 510. Next, the correct coding initiative databases 516 are searched in step 518 for the most extensive procedures and are included in the group. The group is then processed in step 520 in the correct coding initiative rules and a report of the codes and exclusions are generated for human review. After the review, items are selected in the selection step 524 for inclusion in the nugget database 526.

The above system and methods can also be utilized to score or measure existing or proposed benefit plans. In such instances, the specific coverage of the plan under consideration is entered to create a preliminary EOB. The resulting payment/nonpayment items and allowed/disallowed or covered procedures under the plan are identified and reported. Multiple different plans may be compared in this manner and the most appropriate one for a given set of circumstances can be selected. Alternately, a “weighting” system can be applied to each of the aspects of the plan; for example, a numeric value is assigned for covered treatments, co-payments, disallowed treatments and like identified items to generate a relative numeric value for use in comparing systems.

A rules-based system for claim benefit pre-adjudication and related method has been described above in several preferred embodiments. It will be recognized that the edit criteria of the RBS described above establishes clinical consistency with the databases and provides a solid foundation for the multiple edits of the database itself and remains an integral part of the ongoing development and maintenance of the RBS. Therefore the invention has been described by way of illustration rather than limitation.

What is claimed is:

1. A rules-based benefit claim pre-adjudication method for maximizing service provider/medical facility administrative and clinical efficiencies comprising the steps of:
generating a patient benefits plan at the service provider/medical facility location;
defining the treatments and conditions of a patient claim for benefits;
analyzing the patient claim for benefits to generate a preliminary EOB and to determine medical necessity protocols as defined by patient benefit plan and PIC standards;
verifying compliance of treatments and conditions in the patient claim for benefits with applicable standards;
predetermining monetary allowance for medical services rendered based upon applicable payment schedules; and
submitting the pre-adjudicated claim to a designated payer in accordance with the patient benefit plan.

2. The rules-based benefit claim pre-adjudication method as defined in claim 1, further including the step of mapping data elements originating in the medical community to EOB data elements originating in the PIC universe to complete a patient benefits plan to determine the internal protocols of the PIC.

3. The rules-based benefit claim pre-adjudication method as defined in claim 2, further including the step of applying coding initiatives defining treatments interactively or batch with the RBS applicable standards to assure the likelihood of acceptance of a claim for payment.

4. The rules-based benefit claim pre-adjudication method as defined in claim 3, further including the step of applying medical necessity treatments and diagnoses linkages coding appropriateness interactively or batch with the RBS applicable standard to assure the likelihood of acceptance of a claim for payment.

5. The rules-based benefit claim pre-adjudication method as defined in claim 4, further including the steps of:
analyzing a PIC-generated EOB for the benefit claim submitted;
identifying treatments and conditions paid at a different rate than that determined in the pre-adjudicated claim submitted;
identifying exception treatments and conditions qualifying for reimbursements; and
updating the patient benefit plan and rules-based pre-adjudication applicable standards to incorporate the analyzed PIC-generated EOB information whereby the rules-based pre-adjudication system is self-regulating.

6. The rules-based benefit claim pre-adjudication method as defined in claim 5, further including the step of analyzing historical PIC-generated EOBs for other patients in accordance with the updated patient benefits plan to identify additional qualifying treatments and conditions not previously claimed and submitted or previously claimed and rejected.

7. The rules-based benefit claim pre-adjudication method as defined in claim 5, further including the step of analyzing historical PIC-generated EOBs for other patients by ZIP code to identify treatments and conditions qualifying for reimbursement for some patients and not other patients within a given patient's benefits plan, and submitting a benefit claim for the unpaid identified treatments and conditions qualifying for reimbursement.

8. The rules-based benefit claim pre-adjudication method as defined in claim 5, further including the steps of:
analyzing historical PIC-generated EOBs for other patients by different ZIP codes to identify treatments and conditions qualifying for reimbursement for some patients and not other patients within a given patient's benefits plan;
advising a service provider/medical facility having a potential qualifying benefit claim for a previous unclaimed or rejected claim for a patient in the given patient's benefits plan; and
submitting the potential qualifying benefit claim for reimbursement.

9. The rules-based benefit claim pre-adjudication method as defined in claim 3, including the step of applying Medicare correct-coding initiative to the rules-based adjudication system.

10. The rules-based benefit claim pre-adjudication method as defined in claim 3, further including the step of applying proprietary benefit plan specific coding initiatives to the rules-based pre-adjudication system.

11. The rules-based benefit claim pre-adjudication method as defined in claim 3, further including the step of applying insurance company or benefit plan administrator's utilization standards to the rules-based pre-adjudication system.

12. The rules-based benefit claim pre-adjudication method as defined in claim 3, further including the step of validating benefits plan specific medical necessity coding linkages and rules to the rules-based pre-adjudication system.

13. The rules-based benefit claim pre-adjudication method as defined in claim 3, further including the step of applying terms and conditions of agreements between a service provider/medical facility and a managed care organization/insurance company to the rules-based pre-adjudication system.

14. The rules-based benefit claim pre-adjudication method as defined in claim 3, further including the step of re-pricing services rendered at a service provider/medical facility according to a managed care or non-managed care fee schedule.

15. The rules-based benefit claim pre-adjudication method as defined in claim 1, wherein the step of defining treatments and conditions further includes the steps of:
validating patient's information data content;
applying a proprietary claim editor using a relational database comprising coding tables to identify appropriate procedural and diagnostic codes and applicable linkages.

16. A rules-based system for pre-adjudication of a benefits claim, said system comprising:
a source of claim data capable of identifying patient demographics and benefits plan coverage;
means at a benefit provider site for accessing the claim data source to capture historical claim data and update patient's current information;
at least one set of pre-adjudication rules corresponding to the type of patient benefits plan coverage; and
audit processing means for validating in accordance with said at least one set of pre-adjudication rules treatments and conditions coding and identifying applicable related treatments and conditions codes corresponding to the patient's diagnosis and prior treatment history to generate a suggested treatment plan to the provider whereby treatments are matched with conditions and applicable excluded treatments codes are identified.

17. The rules-based system for pre-adjudication of a benefits claim as defined in claim 16, wherein said audit processing means further includes means for comparing, in accordance with said at least one set of pre-adjudication rules, historical PIC-generated EOB results with submitted treatments codes and matched treatments and conditions codes and applicable excluded treatments codes to generate a suggested treatment plan at a more successful payment rate.

18. A method for pre-adjudication of benefits claim submission to a payer, said method comprising the steps of:
preparing benefits claim data including identifying a patient, an insured covering the patient, benefit policy and plan codes applicable to the patient and treatments codes corresponding to conditions performed on the patient by a provider;
analyzing the benefits claim data in accordance with at least one set of predefined rules for conformity of claim data elements to a set of pre-established criteria;
validating the treatments and conditions codes specified in the benefits claim data;
verifying that the correct coding initiatives comply with the benefits policy and plan code identified in the benefits claim data preparation step;
valuating each benefit associated with the specified treatments and conditions codes;
reviewing each identified benefit value in accordance with the Policy Issuing Company agreement terms and conditions and generating a corresponding acceptance message or correction request message;
forwarding the benefits claim to the Policy Issuing Company identified in the benefit claim data preparation step;
presenting the benefits claim to the Policy Issuing Company for generation of an EOB in response to the benefit claim complying with the claim request requirements or in response to provider instructions;
reviewing the PIC-generated EOB to capture remark codes to determine priority of action and generating corresponding trigger messages in response thereto and identifying rule deviations corresponding to benefits claim payments made and non-payment of qualifying benefits claim;
updating said at least one set of predefined rules to incorporate changes resulting from the PIC-generated EOB review step; and
generating messages reflecting priority of benefits claim coding to maximize provider reimbursement.
